(19) United States
(12) Patent Application Publication
(10) Pub. No.: US 2011/0215218 A1
(43) Pub. Date: Sep. 8, 2011

(54) SUPPORT APPARATUS

(76) Inventor: Mark Jarrett, St. Clair Shores, MI (US)

(21) Appl. No.: 13/042,039

(22) Filed: Mar. 7, 2011

Related U.S. Application Data
(60) Provisional application No. 61/311,631, filed on Mar. 8, 2010.

(51) Int. Cl. F16M 11/22

(52) U.S. Cl. 248/440.1

(57) ABSTRACT

A support apparatus may be formed from a single sheet of generally planar material that is cut to define the requisite frame and subparts, and the spaces to position those subparts during use and storage of the apparatus. The support apparatus, which may function as a sawhorse, may be purchased and/or delivered on site as a generally planar unit, the legs and pegs broken out from the frame and the whole apparatus assembled for use. Following use, the apparatus may then be dissembled and reconfigured back into a generally planar configuration for storage and/or transport.

### CROSS-REFERENCE TO RELATED APPLICATIONS

The present application claims priority from U.S. Provisional Patent Application No. 61/311,631, filed Mar. 8, 2010, the disclosure of which is incorporated by reference herein in its entirety.

### FIELD OF THE INVENTION

A support apparatus is disclosed, the frame and subparts of which may be formed from a single sheet of material. More specifically, a sawhorse type support apparatus is disclosed that may be formed from a single piece of material, the subparts broken out and assembled for use. After use, the apparatus may then be disassembled and reconfigured back into a single generally planar unit for storage.

### REFERENCE TO RELATED ART

A sawhorse can be an important piece of equipment on any construction site. A sawhorse might typically include an elongated crossbar that is supported at each end by legs arranged in an A-frame configuration. Sawhorses may be made of wood, plastic, metal, or a combination of those materials, and formed as an integral unit or from the assembly of parts. However, regardless of their configuration, known sawhorses can be bulky and decidedly unsophisticated when it comes to break down and storage. The bulky design can, for example, take up needed space in a truck bed or garage that might otherwise be used for hauling or storing equipment and goods. Therefore, it would be advantageous to have a sawhorse-type support apparatus that is more compact in design and easier to store.

### SUMMARY OF THE INVENTION

A support apparatus is disclosed that may be formed from a single sheet of generally planar material that is cut to define the requisite frame and subparts, and the spaces to position those subparts during use and storage of the apparatus. The frame for the support apparatus may, for example, be formed from a rectangular unit of ¾ inch oriented strand board (OSB). The frame may also be cut using a computer numerical control (CNC) machine to further define it, and “knockoutable” legs and pegs.

In one embodiment that support apparatus may include a planar sheet, with the sheet having a first and a second end, a pair of sides and an interior area. The sheet may have a generally square or rectangular shape, such that the ends are substantially parallel to one another, as are the sides. However, it will also be appreciated that other shapes and configurations may also be used to construct the apparatus.

The interior area may be configured, for example cutting with a CNC machine, to include a first and a second “knockoutable” leg member and also a plurality of peg members. More specifically, each leg member and peg may be originally formed integral to the sheet, but may remain attached to—but separable from—the sheet by use of frangible portions.

The sheet may define one or more cutouts proximate the first end, and also a first and second channel proximate the second end. The cutout may function to receive a crossbar such as a two by four board, and including a space for receiving a peg to frictionally hold the crossbar in the cutout. Each channel may function to receive one of the legs and like include a space for receiving a peg to frictionally hold the leg in the channel.

In use, it will be appreciated that the support apparatus may, for example, be delivered to a worksite in the form of a single planar sheet having any cutouts, channels, spaces, etc already defined in the sheet and the requisite legs and pegs defined as knockoutable elements from the sheet. The apparatus may then be put to use by knocking out the legs and pegs and assembling the unit, legs, etc. Then following use, the apparatus may be disassembled for storage by securing the legs and pegs back within the interior plane of the sheet.

### BRIEF DESCRIPTION OF THE DRAWINGS

Reference will be made herein to the attached figures in which like reference numerals refer to like parts throughout and wherein:

FIG. 1 is a planar view of a face of an embodiment of a support apparatus constructed in accordance with the present invention;

FIG. 2 is a planar side cutaway view taken along line 2-2 of FIG. 1 showing the configuration of a breakaway cut between the frame and a leg;

FIG. 3 is a planar side cutaway view taken along line 3-3 of FIG. 1 showing the configuration for a breakaway cut between a peg and a leg;

FIG. 4 is a planar view of an opposite face of the support apparatus shown in FIG. 1;

FIG. 5 is an exploded perspective view of the support apparatus of FIG. 1 with the legs and pegs broken away from the frame;

FIG. 6 is a perspective view showing a leg in position to be received by a channel of the frame and a peg positioned to be received by a space of the channel;

FIG. 7 is a perspective view of the support apparatus of FIG. 1 with the legs in the assembled position held by pegs and showing a crossbar and peg prior to insertion in the cutout;

FIG. 8 is a planar view of a face of the support apparatus of FIG. 1 with the pegs and legs configured for storage;

FIG. 9 is a planar side view showing a pair of support apparatus linked by a crossbar and using an optional strut member to brace the crossbar;

FIG. 10 is a planar top view of the support apparatus configuration shown in FIG. 9;

FIG. 11 is a planar side view of the optional strut member;

FIG. 12 is a planar partial front view of an embodiment of the support apparatus including a modified strut cutout for receiving a strut;

FIG. 13 is a planar partial side view of an embodiment of a strut configured to engage the strut cutout of FIG. 12;

FIG. 14 is a perspective view of the embodiment of the support apparatus of FIGS. 12 and 13 showing the strut aligned with the strut cutout;

FIGS. 15A-15C a side cutaway view of the strut of FIG. 13 engaging the modified cutout of FIG. 12; and

FIG. 16 is a perspective partial view of the support apparatus of FIGS. 12 and 13 with the strut secured to a crossmember.

### DETAILED DESCRIPTION OF THE INVENTION

An embodiment of a support apparatus may be formed from a single sheet of generally planar material that is cut to define the requisite frame and subparts, and the spaces to position those subparts during use and storage of the apparatus. The frame for the support apparatus may, for example, be formed from a rectangular unit of ¾ inch oriented strand board (OSB). The frame may also be cut using a computer numerical control (CNC) machine to further define it, and “knockoutable” legs and pegs. The requisite channels and cutouts may also be defined in the frame for positioning the legs and pegs during use and storage. Thus, it will be appreciated that the disclosed support apparatus may be purchased and/or delivered on site as a generally planar unit, the legs and pegs broken out from the frame and the whole apparatus assembled for use. Following use, the apparatus may then be dissembled and reconfigured back into a generally planar configuration for storage and/or transport.

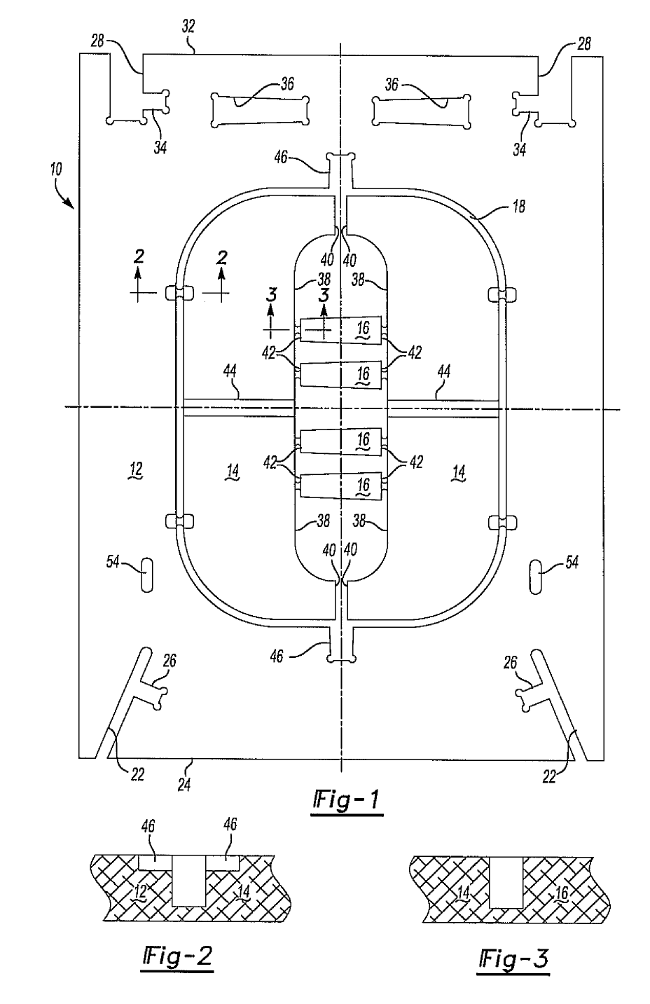

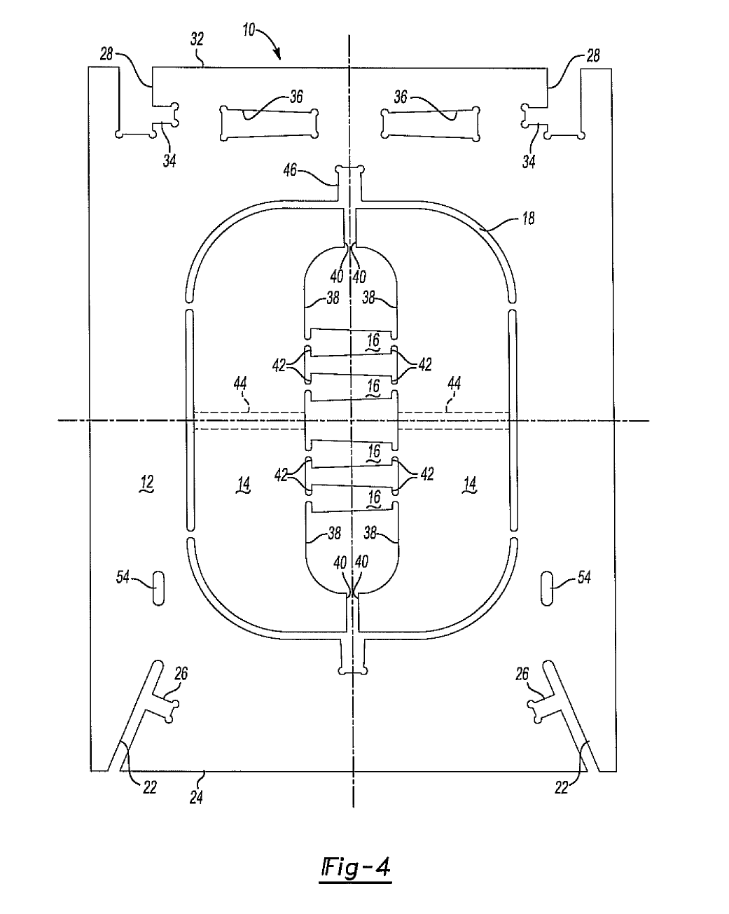

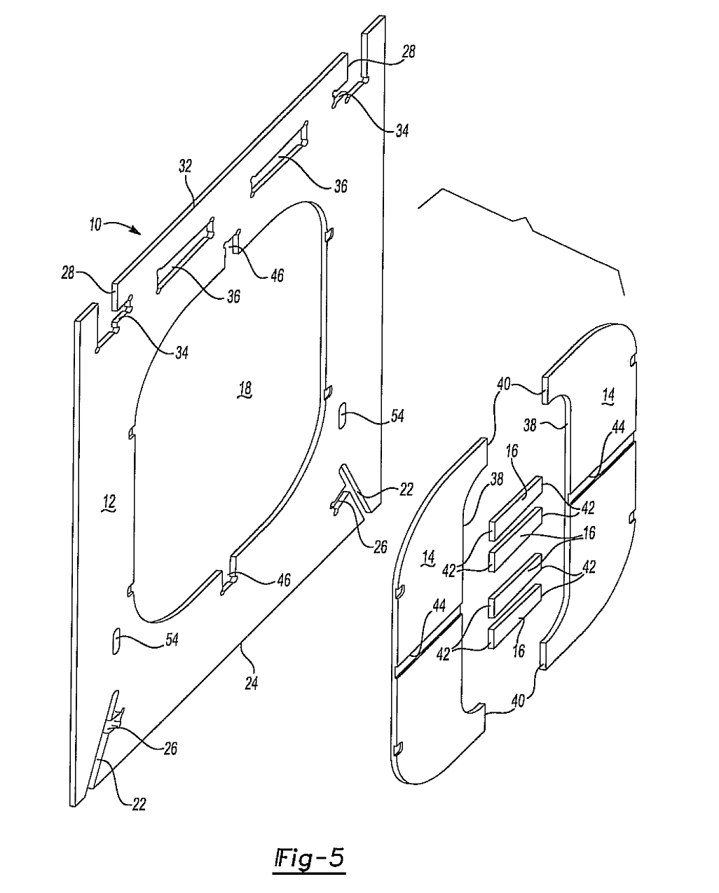

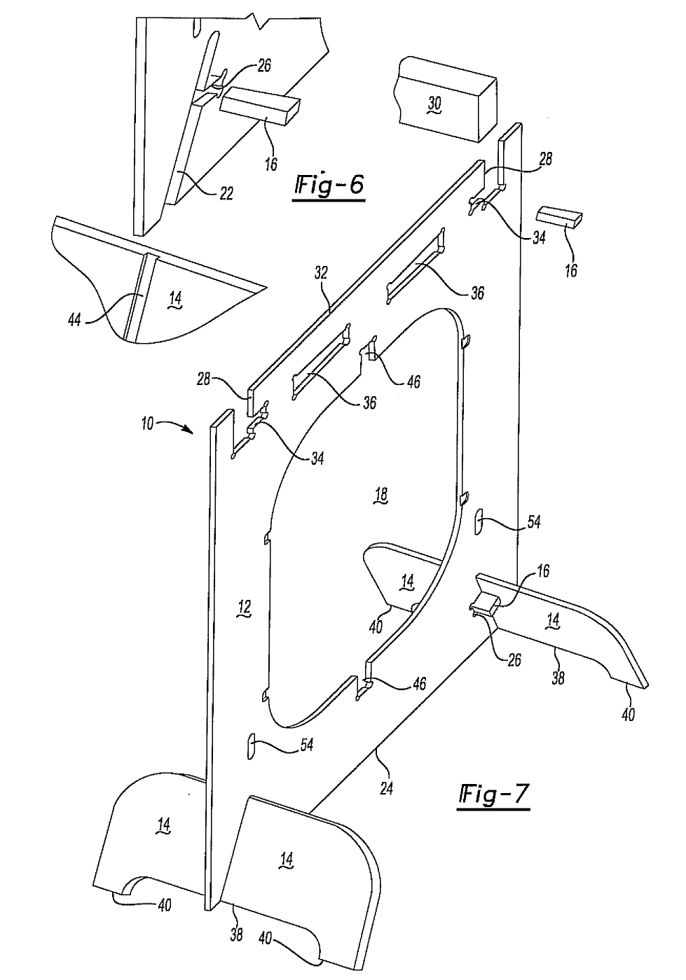

Referring now to FIGS. 1-10, and as best shown in FIGS. 1 and 5, an embodiment of a support apparatus 10 may include a frame 12, legs 14 and pegs 16. The legs may function to maintain the frame 12 in a generally vertical orientation. The pegs 16 assist in retaining the legs 16 in or to the frame 12.

As mentioned supra, the frame 12 may be formed from a generally rectangular sheet of OSB, with the legs 14 and the pegs 16 being formed or defined from the same sheet of OSB. For example, as shown the legs 14 and pegs 16 may be cut from an interior area 18 of the frame 14. Channels 22 may be defined along an edge 24 of the frame 14, with each channel 22 being dimensioned to receive one of the legs 14 (as will be described infra). Each channel 22 may also include a space 26 into which a peg 16 may be inserted to assist in frictionally retaining the leg 14 in the channel 22. Each space 26 may be defined in the frame 12 substantially perpendicular to a wall of the channel 22. It will, however, be appreciated that other positions for each space 12 may also be used. Cutouts 28 shaped to receive a crossbar 30 (such as a 2×4) may be defined in the frame 12 along an edge 32 opposite the channel(s) 22. These crossbar cutouts 28, like the channels 22 for the legs 14, may each feature a space 34 for insertion of a peg 16. Each space 34 may likewise be defined in the frame 12 substantially perpendicular to a wall of the cutout 28. It will, however, be appreciated that other positions for each space 34 may also be used. Storage cutouts 36 for the pegs 16 may also be defined in the frame 14 for storing the pegs 16 used to retain the crossbar(s) 30 when not in use.

Still referring to FIGS. 1-10, as mentioned supra the frame 14 of the disclosed embodiment, and indeed the whole support apparatus 10, may be constructed from a single sheet of OSB. It will be appreciated, however, that other materials such as plywood, metal, metal alloys, and synthetic materials may also be used. It will also be appreciated that two or more support apparatus 10 may be formed from a single large sheet of material. For example, six support apparatus 10 measuring approximately 23⅝×31⅝ inches may be formed from a standard ¾ inch 4×8 foot sheet of OSB material. In addition, while ¾ inch material may be used, it may also be convenient to use material in a range between ½ inch and ¾ inch, or larger depending on the needs of the user.

Still referring to FIGS. 1-10, in the embodiment shown in the figures the pegs 16 may be formed by cutting material away from the interior 18 of the frame 12 to define each peg 16 and a lower edge 38 and/or the feet 40 of each leg 14. Moreover, in order to maintain the support apparatus 10 as an integral whole prior to its initial use and allow each peg to be knocked away from the frame 14, a ⅛ inch of material may remain uncut (see FIG. 3) such that each end 42 of each peg 16 is secured between and to the lower edge 38 of each leg 14.

Still referring to FIGS. 1-10, in the embodiment shown in the figures, each leg 14 may likewise be formed by cutting material away from the interior 18 of the frame 12, with each leg 14 including a positioning groove 44 defined on one side and along the leg's 14 vertical centerline. However, like the pegs 16, and as best shown in FIG. 2, prior to an initial use of the support apparatus 10, each leg 14 may remain integrally connected to the frame by an ⅛ inch of material. Recesses 46 may also be provided proximate each strip of material to function as thumbholes for each leg 14 during use.

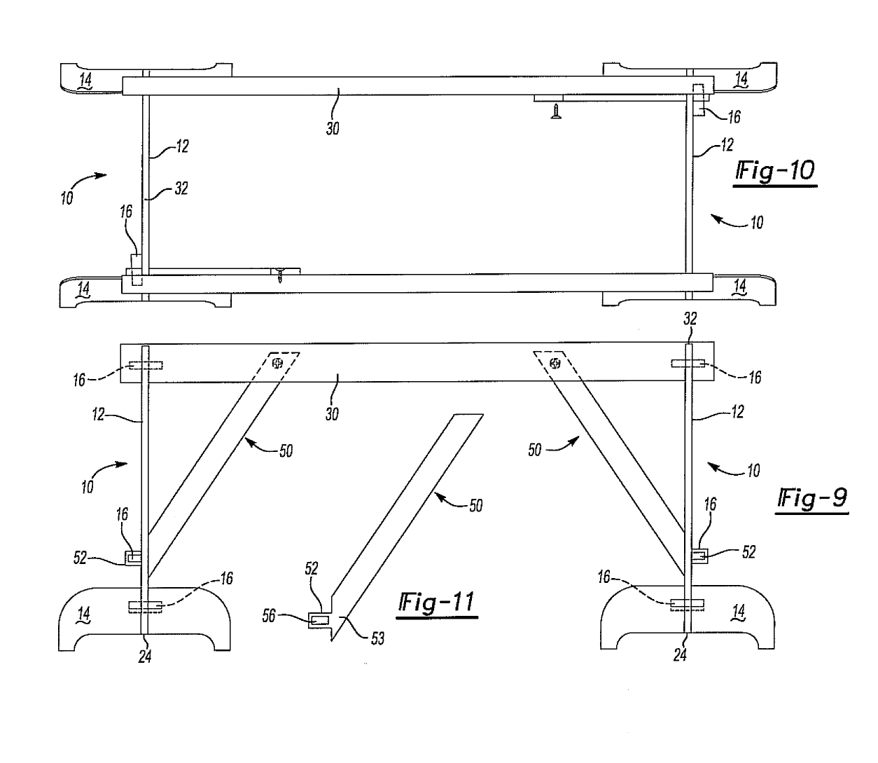

Still referring to FIGS. 1-10, and as best shown in FIGS. 5, 6 and 7, prior to the first use of the support apparatus 10, the pegs 16 and legs 14 may be broken away and/or separated from the frame 14. Each leg 16 may then be inserted along its positioning groove 44 into one of the channels 22 provided in frame 14, and then retained in positioned by inserting a peg 16 into the space 26 of the channel 22. Crossbars 30, such as standard 2×4 foot boards may then be inserted in the cutouts 28 and likewise retained in place using the pegs 16. Thus, as generally shown in FIGS. 9 and 10, two or more support apparatus 10 may be used in conjunction with one or more crossbars 30 to form a support surface for construction materials or the like (not shown).

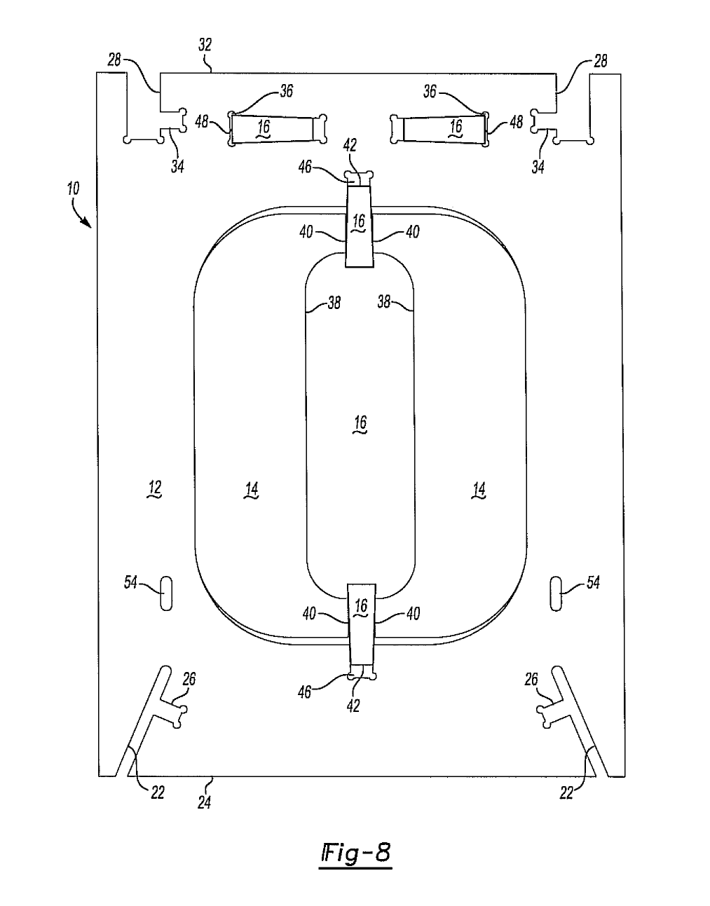

Still referring to FIGS. 1-10, and as best shown in FIG. 8, the pegs 16 and legs 14 of the support apparatus 10 may be stored in the various interior area 18 and cutouts 36 defined within the plane of the frame 14. For example, each leg 14 may be positioned within the interior 18 of the frame 14 and then frictionally retained in position against an edge of the interior 18 by pegs 16 that engage the feet 40 of the legs 16 and fit within a channel 46 defined in the frame 12 at ends of the interior area 18. Pegs 16 used to retain the crossbar(s) 30 in the cutouts 28 may then be stored within the storage cutouts 36 of the frame 12. It will also be appreciated that the pegs 16 stored in the cutouts 36 may be kept from passing through the cutout 36 by friction and also by spurs 48 that may remain on an end 42 of each peg 16 after the peg 16 is initially broken away from the frame 14.

Referring to FIGS. 1-11, and as best shown in FIGS. 9, 10 and 11, an optional strut member 50 may be provided as a brace for each crossbar 30. For example, as shown in FIG. 9, each strut 50 may include a tongue 52 at one end 53 that may be inserted in a strut cutout 54 in the frame 14. The tongue 52 of each strut 50 may have an aperture 56 therethrough for receiving a peg 16 so that the strut 50 may be removably mounted to the frame 14. Then, as best shown in FIG. 9, an opposite end 58 of the strut 50 may be fastened to a crossbar 30.

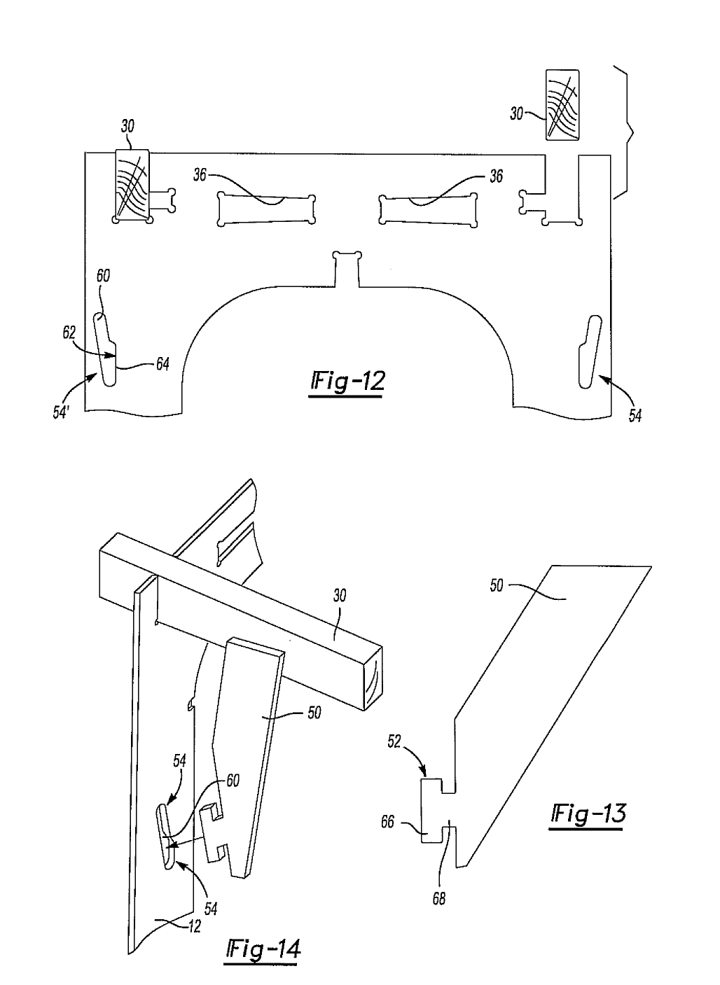

Referring to FIGS. 12-16, the tongue 52 of each strut member 50 may be a T-shaped tongue that is configured to engage an embodiment of the cutout 54′. The cutout 54′ may include a generally diagonal (vertically offset) elongated aperture 60 through the frame 12 that may further include a side 62 having a generally vertical section 64. As will be described further infra, a head 66 of the T-shaped tongue may be dimensioned to that it may be passed through the aperture 60 and a tail 68 of the tongue may be dimensioned so that it may frictionally engage the vertical section 64 of the aperture 60.

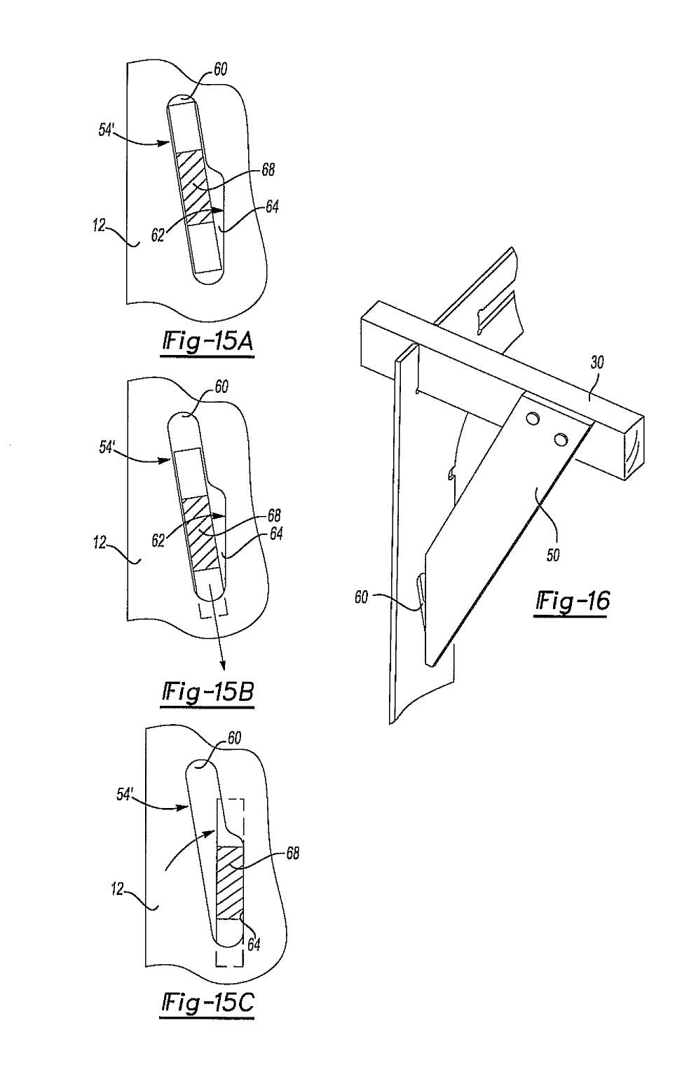

Referring now to FIGS. 15A-15C and 16, to position the strut 50 on the frame 12, the strut member 50 may be oriented (vertically offset) such that a head portion 66 of the T-shaped tongue 52 is aligned with the aperture 60 on one side (interior side) of the frame 12. The tongue 52 may then be passed though the cutout 54′ so that the head portion 66 extends from the opposite (exterior) side of the frame 12. Then, as best shown in FIGS. 15C and 16, the strut 50 may be rotated to vertical such that the tail 68 of the tongue 52 engages the generally vertical section 64 of the aperture 60. Then, as shown in FIG. 16, an opposite end 58 of the strut 50 may be fastened to a crossbar 30.

Having thus described embodiments of this invention, various other embodiments will become apparent to those of skill in the art that do not depart from the scope of the claims.

1. A support apparatus comprising:
a planar sheet, a first and a second leg member, and a plurality of peg members, the sheet having a first and a second end and a pair of sides, and defining an open interior area, a cutout proximate the first end, and a first and second channel proximate the second end, the cutout being dimensioned to receive a crossbar and including a peg receiving space, one of said legs being received in each channel, and each channel including a peg receiving space, and a peg being received in the peg receiving space, with each peg engaging a portion of the leg in the channel to frictionally secure the leg in the channel.

2. The support apparatus of claim 1 wherein the sheet further defines a peg cutout, the peg cutout being dimensioned to receive a peg within the plane of the sheet.

3. The support apparatus of claim 1, wherein the sheet further defines a strut cutout.

4. The support apparatus of claim 3, further comprising a strut having an end configured to be received by the strut cutout.

5. The support apparatus of claim 1, wherein the interior area is dimensioned to receive the first and second leg within the plane of the sheet.

6. The support apparatus of claim 5, wherein the interior area includes a pair of ends and a peg receiving channel is defined in the sheet at each end of the interior area.

7. The support apparatus of claim 1, wherein the peg receiving space of the cutout extends substantially perpendicular to a side of the cutout.

8. The support apparatus of claim 7, further comprising a peg member positioned in each peg receiving space of each channel perpendicular to the plane of the sheet.

9. The support apparatus of claim 1, wherein the peg receiving space of each channel extends substantially perpendicular to a side of the channel.

10. The support apparatus of claim 1, wherein each leg comprises a positioning groove.

11. The support apparatus of claim 1, comprising at least two cutouts proximate the first end, each cutout receiving a cross bar.

12. The support apparatus of claim 1, wherein the sheet comprises oriented strand board.

13. A support apparatus comprising:
a planar sheet, the sheet having a first and a second end, a pair of substantially parallel sides, and an interior area, the interior area including a first and a second leg member and a plurality of peg members, each leg member and peg being formed integral to the sheet and at least each leg being attached to the sheet by a frangible portion, the sheet defining a cutout proximate the first end, and a first and second channel proximate the second end, the cutout operating to receive a crossbar and including a peg receiving space, the each channel including a peg receiving space and operating to receive one of said legs.

14. The support apparatus of claim 13, wherein the interior area includes a pair of ends and a peg receiving channel is defined in the sheet at each end of the interior area.

15. A support apparatus comprising:
a first and a second planar sheet, each sheet including a first and a second leg member, and a plurality of peg members, each sheet also having a first and a second end and a pair of substantially parallel sides, and each sheet defining an open interior area, a cutout proximate the first end, and a first and second channel proximate the second end, the cutout operating to receive a crossbar and including a peg receiving space, each channel including a peg receiving space and one of said legs being received by each channel to support each sheet in a substantially vertical orientation; and
an elongated crossbar extending between the first and second sheets, one end of the crossbar being received in each cutout of the sheets.

16. The support apparatus of claim 15, further comprising a strut.

17. The support apparatus of claim 15, wherein each leg comprises a positioning groove.

18. The support apparatus of claim 15, wherein the interior area of each sheet is dimensioned to receive the first and second leg within the plane of the sheet.

19. The support apparatus of claim 15, further comprising a strut, the strut having one end received in the strut cutout of a sheet and an opposite end secured to the crossbar.

20. The support apparatus of claim 19, wherein the strut cutout comprises a vertically offset aperture extending through the frame and having a generally vertical section.
